(19) United States
(12) Patent Application Publication
(10) Pub. No.: US 2020/0353465 A1
(43) Pub. Date: Nov. 12, 2020

(54) DEVICE FOR PROTECTING AND SEALING THE OPENING OF A CONTAINER

(71) Applicant: Psomagen, Inc., Rockville, MD (US)

(72) Inventors: Zachary Apte, San Francisco, CA (US); Jessica Richman, San Francisco, CA (US); Daniel Almonacid, San Francisco, CA (US); Constance Norris, San Francisco, CA (US); Rodrigo Ortiz, San Francisco, CA (US)

(21) Appl. No.: 16/642,136

(22) PCT Filed: Aug. 28, 2018
(86) PCT No.: PCT/US2018/048410

§ 371 Date: Feb. 26, 2020

Related U.S. Application Data
(60) Provisional application No. 62/551,157, filed on Aug. 28, 2017.

(51) Int. Cl. B01L 3/00

(52) U.S. Cl. CPC B01L 3/50825; B01L 2300/042; B33Y 80/00; B01L 2300/123; B01L 2300/043

(57) ABSTRACT

Embodiments of a device for protecting and sealing the opening of a container. This device is a one-piece made plug for a flask or container, comprising at least one passing channel, and at least one structural flow regulator barrier, allowing the passing of solid elements. The structural regulator barrier comprises at least a gate to regulate the passing and connection between the inside space and the outside space of the container in a unidirectional and/or bidirectional way. An embodiment includes a method and a mold for manufacturing such a device.

### CROSS-REFERENCE TO RELATED APPLICATIONS

This application claims the benefit of U.S. Provisional Application Ser. No. 62/551,157 filed 28-Aug.-2017, which is herein incorporated in its entirety by this reference.

### TECHNICAL FIELD

The disclosure generally relates to devices and tools used in experimental and diagnostic laboratories.

### BACKGROUND

For almost any kind of industry, time is one of the most relevant aspects for planning and choosing a process since the time is related to the productive capacity of the factory and consequently to monetary resources. Thus it is relevant that the number of stages in a process to be the minimum possible, so as to save time and resources besides decreasing probabilities of error implying bounded productive lines.

For biological samples processing in health contexts, for example, the removal of the lids of the tubes in which the samples are contained, and their subsequent reincorporation to them, represents at least two additional stages in the process, which imply a relevant cost of time and resources, increasing at the same time the risk of cross contamination and other subsequent errors.

### SUMMARY

A device in the form of a one-piece made plug for protecting and sealing the opening of a flask or container is provided, comprising at least one passing channel, and at least one structural flow regulator barrier, allowing the passing of solid elements. The structural regulator barrier comprises at least a gate to regulate the passing and connection between the inside space and the outside space of the container in a unidirectional and/or bidirectional way. The passing channel comprises a preset configuration of the passing channel in which the configuration of its shape, geometry and materiality allows the passing of solid elements, wherein the structural regulator barrier comprises at least a gate to regulate the passing and connection between the inside space and the outside space of the container in a unidirectional and/or bidirectional way, including a system for modulating the variation or the change of the volumetric spatial disposition of the structural flow regulator barrier, from an initial state to a second state, wherein the initial state blocks the passing channel and the second state allows the passing through the channel in a unidirectional and/or a bidirectional way.

The device allows to access the sample contained by the receptacle or container with no need to remove the cap from it, but at the same time, to be able to keep the sample isolated from the outside of the container and not allow its accidental exit. Similar to what can be observed in the bags of serum that are used in hospital contexts and the like, but in this case it does not restrict the access to something that can pierce the entry as happens in case of needles and other kind of punches, which allows it to be used by less rigid objects such as plastic tips.

Furthermore, the device offers faster processing of samples since less steps are required, and the tasks are able to be completed in a shorter time, compatible with manual and automated contexts.

The device also allows saving resources by eliminating tasks from the process. There is no longer need of other tools or other kind of resources focused uniquely on the plug or any equivalent removing. In addition, the smaller the number of stages, the lower the probability of error, thus allowing a bigger number of processes to be completed in a determined period of time, which in addition leads to performance improvements, implying a considerable increasing in the efficiency and effectiveness of the processes.

The plug described herein also decreases the probability of cross contamination. As there is no removal of the plugs any longer, so the interior of the container is less exposed to the contamination or fall of external elements.

The use of this plug moreover enables a more efficient and effective processing of samples contained in containers in a manual or automated way or when handling large sample quantities. It also keeps in a lower level the likelihood of error and risk of cross-contamination between samples.

In the context of this patent application, “plug” generally refers to a physically independent part that when incorporated in the overture or opening of a for instance cylindrical container, isolates the exterior from the interior of the receptacle, an action that can be referred to as “sealing”.

A “passing channel” is denominated as a route previously set and physically constituted, in a partial or complete way, through which the solid element passes from the outside to the inside of the container and/or vice versa.

Two main functions can be described herein: the first function is associated with sealing a container, and in addition, as a second and simultaneous function is to allow access to the interior of the container with no need of removing the plug, maintaining inner space of the container separated from outer space of the container, improving preservation of the sample and protecting content from manipulation and manipulation-derived contamination of the sample.

The structural flow regulator barrier may permanently block the channel unless the access is unlocked by the application of a perpendicular force over the gate surface exerted by a solid body, which causes a variation of spatial arrangement over the gate itself, allowing the mentioned solid body to pass through the passing channel.

The plug may comprise a system to reset the initial volumetric spatial disposition of the gate position when the perpendicular force exerted by a solid body over the regulator barrier is no longer exerted.

Preferably, the access is activated by the application of a force without breaking or causing any structural damage to the plug, so can be reused in a specific, variable or unlimited amount of times, and wherein the plug can be operated with the interaction of a range of solid objects.

Therein, the range of solid objects for interaction with the plug may comprise: rounded, sharp, conical, flat and beveled objects, and any combination of them.

The plug may furthermore be made of an elastomer material, wherein the elastomer material can be selected from at least one of the followings materials: is chosen from styrenics, olefinic, vulcanized thermoplastics, thermoplastic polyurethane, copolyesters, and copolyamides materials.

Embodiment can include a method for manufacturing the aforementioned plug, wherein the method comprises at least one of the following steps or stages:

a. pre-analysis, and

b. materialization.

wherein, the stage of pre-analysis comprises:
a1. observation for detection of possibility of intervention,
a2. problematization,
a3. solution strategy, and
a4. design proposals;

and wherein the stage of materialization comprises:
b1. mock-up,
b2. modeling for the physical and actual representation of the plug,
b3. digital prototype and template,
b4. manufacture of template and prototype.
b5. performance evaluation,
b6. testing prototype in real conditions, use and circumstances, and
b7. scaled production

The step of manufacturing the template and prototype may include at least one of the following steps: 1) casting in combination with a rapid prototyping tool manufacturing process to obtain the positive (mold); 2) 3D printing; 3) machining by roughing, for instance by a manual, computerized or mixed process; and 4) conforming by deposition of material.

The step of manufacturing of the template and prototype may comprise a conformation molding process, including the elaboration of a mold for conforming at least one unit of a single-piece plug.

The mold for conforming the plug may comprise elaboration of multiple units of a single-piece plug, simultaneously or successively.

The scaled production may include at least one of the following steps: 1) casting, 2) injection molding, and 3) extrusion molding.

The materialization stage can comprise any format of computer-readable information directly, intentional or derived from digital prototyping or a manufacturing process involving the use of an automated machine, preferably at any time of the manufacture process.

The computer-readable information can comprise at least one of the following: numerical control programming language, parametric design approach, mesh design approach, and any combination of them.

Embodiments can include a plug for a flask or container, preferably made of one piece, produced by the aforementioned method.

Embodiments can include a plug/container assembly, comprising a flask or a container and an aforementioned plug, the plug being attached or connected to the flask or container.

Therein, the container or flask could of course comprise a sample.

### BRIEF DESCRIPTION OF THE FIGURES

FIG. 1 includes an overview of the plug variation 1 and different views of it.

FIG. 2 includes a slide axial plane of the plug variation 1 to highlight the passing channel (A) and the gate (B), as well as bottom and top views of them.

FIG. 3 includes a schematic use the plug variation 1 with a pipette passing through the gate.

FIG. 4 includes an overview of an alternative embodiment of the plug variation 2 and different views of it.

FIG. 5 includes a median plane of the plug variation 2 of FIG. 4 to highlight the passing channel (A) and the gate (B), as well as bottom and top views of them.

FIG. 6 includes a schematic use the plug variation 2 of FIG. 4 with a pipette passing through the gate.

FIG. 7 includes a blueprint view of the plug variation 1 with measures in mm to build an embodiment of it.

FIG. 8 includes a blueprint view of the plug variation 2 of FIG. 4 with measures in mm to build an embodiment of it.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed.

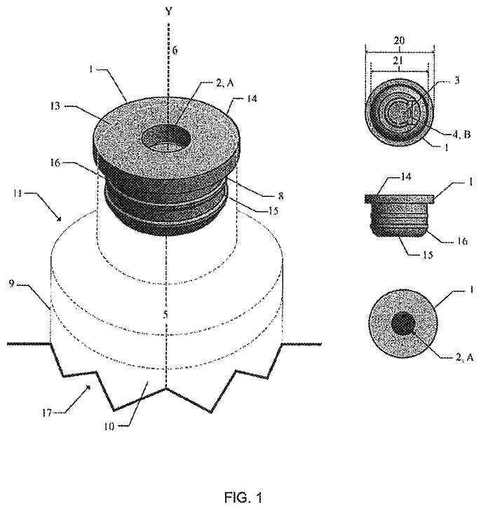

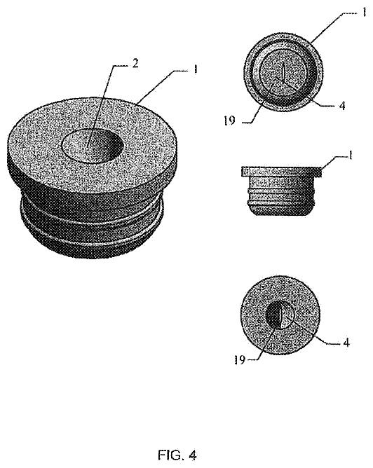

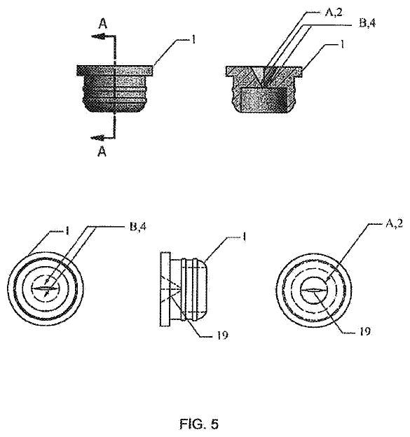

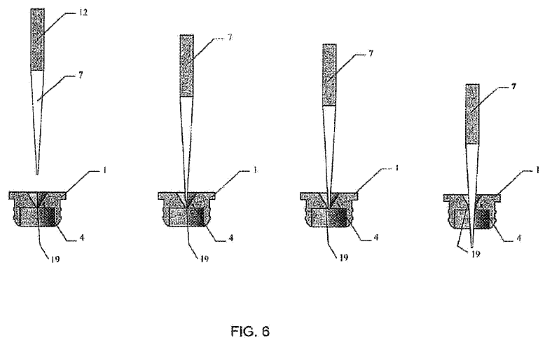

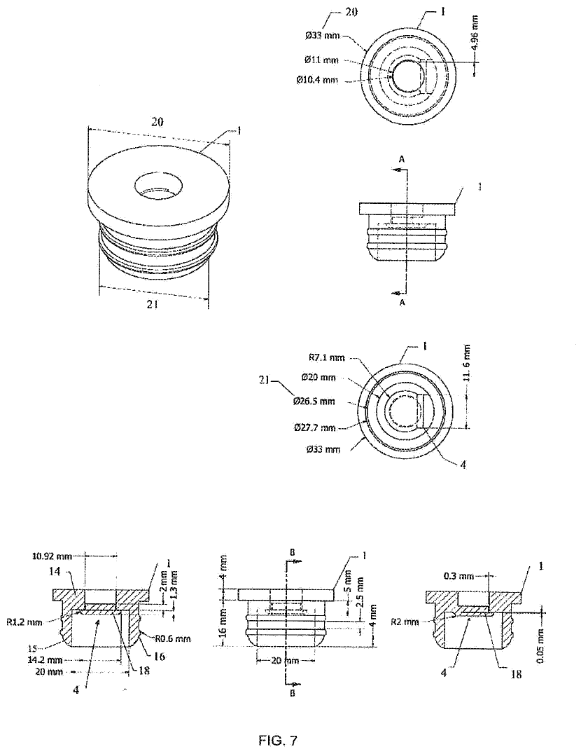

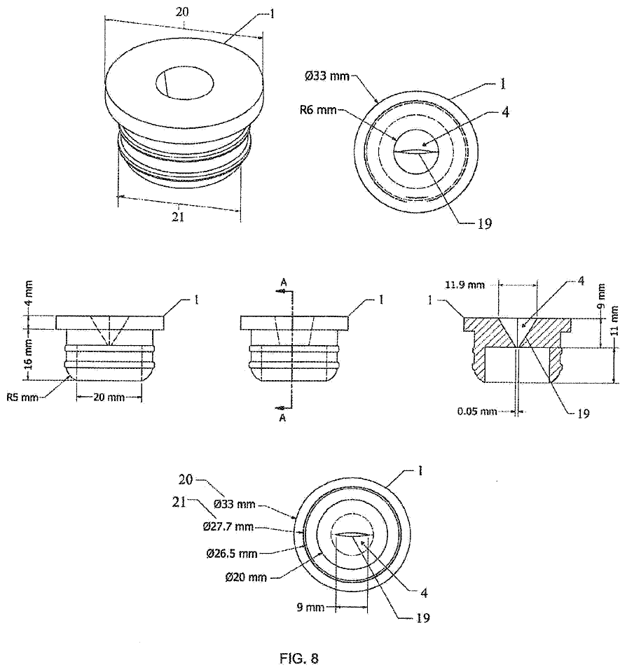

As shown in at least one of FIGS. 1-8, variations can include a plug 1 with a pre-set passing channel 2 in which the conjugation of its shape, geometry and materiality allows the passage of solid elements or bodies 7 that applies a perpendicular force (Y axis) to the structure 3 that exerts the axial closing that seals the passing channel 2 (FIG. 4 and FIG. 5A), denominated “gate(s)” 4 (FIG. 5B) for this patent application's purposes (FIG. 6). FIG. 1 includes an overview of the plug variation 1 and different views of it. A plug 1 is shown, comprising an external head part 14 connected to an internal, elongated main body part 15, the plug 1 being arranged in an opening 13 of a flask or container 9. Preferably, the external head part 14 and the internal main body part 15 are formed integrally, i.e. as one piece, preferably comprising an elastomeric material 8. The external head part 14 and the external main body part 15 are preferably rotationally symmetric around the Y-axis, for instance having a cylindrical shape. The outer diameter 20 of the external head part 14 could for instance amount to 1-8 cm, preferably 2-6 cm, more preferably 3-5 cm, although other dimensions are, of course, also conceivable. The outer diameter 21 of the internal main body part 15 could for instance be 60-90%, such as 80-90%, of the outer diameter 20 of the external head part 14. The passing channel 2 could have a diameter of for instance 40-60% of the outer diameter 20 of the external head part 14. FIGS. 6 and 7 show several preferred dimensions for the plug variations 1 and 2. The internal main body part 15 could be provided with one or more radial protrusions 16, such as rings, in particular two rings, to provide a better seal. The container 9 may comprise a sample 10 on the inside (space) 5. For sake of clarity, the outside (space) is indicated with reference numeral 6. The assembly of plug 1 and container 9 is indicated with reference numeral 17.

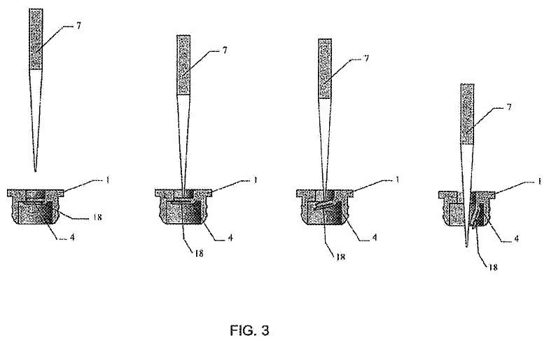

FIGS. 1-3 show variation 1 of the plug 1, wherein the gate 4 comprises a flexible or elastically deformable flap 18. FIG. 3 shows the gate 4 being pierced by a solid body or element 7. Therein, the flexible flap 18 bends or flexes towards the inside (space) 5 of the container 9, without being structurally damaged. The flexible flap 18 furthermore returns to its initial position/state when the solid body 7 is removed again. The solid element or body 7 may have a relatively sharp, flat end, tapering shape (like a javelin), such as a pipette 12 as shown, although other shapes are also conceivable.

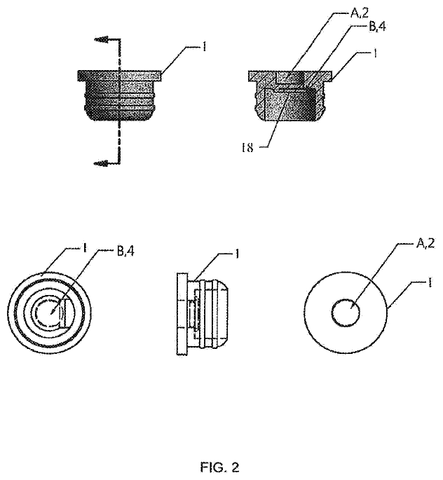

The conjugation of its shape, geometry and materiality allows the passage of solid elements or bodies 7 by applying a perpendicular force (Y axis) to the structure 3 that exerts the axial closing that seals the passing channel 2 (FIG. 1 and FIG. 2A), denominated “gate(s)” 4 (FIG. 2B) for this patent application's purposes (FIG. 3).

The first function is a result of a concentric volume compatibility with the overture or opening 13 of the vessel 9 and its fabrication is in an elastomer material 8 (e.g. Styrenics (SBCs), Olefinic (TPOs), Vulcanized thermoplastics (TPVs), Thermoplastic polyurethane (TPUs), Copolyesters (COPEs), Copolyamides (COPAs), etc.) that enables to adapt the perimetral expansion of the plug 1 to the boundaries set by the volume of the overture or opening 13 itself.

Elements passing through the channel 2 are regulated by the structure 3 localized in the passing channel 2 itself, denominated as “gate (s)” 4 that obstruct(s) the route, blocking the pass of any element from (in/out)side to (out/in)side 5, 6. In order to unlock the access, the object 7 to be introduced into the container 9 exerts a perpendicular force over the “gate (s)” 4 which generates a change of spatial arrangement over it, thus allowing the object 7 to pass through the passing channel 2. At the moment when the force is no longer exerted over the structure 3, the gate 4 returns to its initial spatial arrangement (FIG. 3 or FIG. 6).

FIGS. 4-6 show variation 2 of the plug 1, wherein the gate 4 comprises a slit 19 (instead of a flap 18). The slit 19 opens when a solid object or body 7, such as a pipette 12, is inserted (FIG. 6), but (elastically) returns to its original state/shape when the solid body 7 is removed again.

The plug 1 having the previously mentioned properties, improves the efficiency of several processes, especially in industrial contexts, since it is no longer required to remove the plug 1 from the container 9 (e.g. flask, tube, vessel, vial, etc.) for accessing the content in it. This means that stages as removing plugs 1 and putting them back are no longer needed, thus saving time and resources.

In a variation of an embodiment, wherein efficiency, contamination and errors risk cases of automated samples processing in health contexts, are vital, the alternative to be able to process the samples 10 (access to the interior of a container, either to extract or to add a fluid from/to inside) in fewer steps is relevant and of paramount important. Since part of the process usually considers steps uniquely or focused on the removal of the container plugs 1, and may even extend to three steps or more of a considerable complexity (due to the number of tasks and/or steps to be developed and suggested by protocol), depending on the characteristics of the container 9 and context (protocol). These critical steps can result in loss of resources and time when executing a series of steps and stage(s) to adapt the physical conditions necessary to carry out a particular process. Therefore, the use of automated devices involves movement by routes delimited by the mechanical conditions of the equipment, therefore it is common to pass through the point of a given position at least in two occasions per movement (e.g. when going to the containers and return).

In cases where the content of the container 9 is removed totally or partially, or it just has some kind of contact with the equipment, returning to the original position means a high risk of cross contamination with other samples, due to possible drips or falls of residual sediments during such a contact. In a specific example, as a result of using the plug and/or system at automatized or massive processing of contents and samples 10, removal of the plugs 1 is no longer required in the process, and the interior 5 of the containers 9 is no longer exposed to the fall of external elements, which reduces the risk of contamination between containers 9.

In addition, when using the plug 1 in a sample analysis pipeline (e.g. manually or automatically) improvement of the time of processing set, of samples can be achieved. The time of sample processing can be thus reduced between 5% and 60% of the total time for sample processing. This improvement can include also an optimization of the use of the resources when processing samples in productive contexts. These resources can include at least one of the followings: physical resources, human resources, material resources, economical resources, and any combination of them.

The materialization process (e.g., for the plug and/or components of the system) can include at least four stages of pre-analysis and at least eight stages of materialization. The pre-analysis includes: observation, which is the detection of possibility of intervention; problematization, which is the definition of the problems related to the function development or performance and hypothesis of its possible causes; solution strategy, that is the definition of functional objectives and possible ways of implementation in the design; and the design proposals, which is the formal approach detached from the objectives defined in the strategy.

The materialization can additionally or alternatively include: 1) mock-up, which is the physical design of principle(s) applied to the design(s); 2) modeling, which is the physical representation of the plug and/or system, in its true magnitude; 3) construction of a digital mold and prototype; 4) manufacture of a mold and prototype, which is the preferred method of manufacture being the case for casting in combination with a rapid prototyping tool manufacturing process to obtain the positive (mold), but whose manufacture is also compatible with 3d printing, machined by roughing (manual, computerized or mixed), or conforming by deposition of material; 5) performance evaluation; 6) repetition of steps 4 and 5 according to the results obtained, as many times as necessary; 7) use evaluation, which is testing the prototype in real conditions, uses and circumstances; and 8) implementation and evaluation of an alternative manufacturing process compatible, according, to the scale (number of units and commercial context), which in case of being projected for massive markets, casting still as first alternative preference, injection and extrusion molding as second and third, respectively.

In a first variation, a preferred alternative method of elaboration material for prototyping may include the following steps: 1) casting in combination with a rapid prototyping tool manufacturing process to obtain the positive (mold); 2) 3d printing; 3) machining by roughing, which in this methodology could be addressed by a manual, computerized or mixed process; and 4) conforming by deposition of material.

For massive production, the (preferred) method can include at least one of the following: 1) casting, 2) injection molding, and 3) extrusion molding.

Although omitted for conciseness, the (preferred) embodiments can include every combination and permutation of the various system components and the various method processes, including any variations, examples, and specific examples, where the method processes can be performed in any suitable order, sequentially or concurrently.

The system and method and variations thereof can be embodied and/or implemented at least in part as a machine configured to receive a computer-readable medium storing computer-readable instructions, for designing user-computer communication as a parametric design approach, a mesh design approach and any combination of them, wherein the aforementioned base technique for their performance is defined by an algorithmic scheme that allows introducing variables, parameters, volumes, spatial limits, etc. to establish a relationship between these and a virtual object.

Also for fabricating computer or machine-readable instructions as Numerical control programming language (CNC) (e.g.: g-code, c-code, a-code) technique based on an algorithmic scheme that allows introducing variables, parameters, volumes, spatial limits, etc. to establish a relationship between these and a virtual object.

The instructions are preferably executed by computer-executable components preferably integrated with the system. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments without departing from the scope defined in the following claims.

### LIST OF REFERENCE NUMERALS

1. Plug
2. Passing channel
3. Structural flow regulator barrier
4. Gate
5. Inside space
6. Outside space
7. Solid body
8. Elastomer material
9. Container or flask
10. Sample in container or flask
11. Plug/container assembly
12. Pipette
13. Opening
14. External head part
15. Internal main body part
16. Radial protrusion
17. Assembly of plug and container
18. Flexible or elastically deformable flap
19. Elastically deformable slit
20. Outer diameter of external head part
21. Outer diameter of internal main body part

We claim:

1. A plug for a flask or container, preferably made of one piece, comprising:
a. at least one passing channel, and
b. at least one structural flow regulator barrier,
wherein the passing channel comprises a preset configuration of the passing channel in which the configuration of its shape, geometry and materiality allows the passing of solid elements, and wherein the structural regulator barrier comprises at least a gate to regulate the passing and connection between the inside space and the outside space of the container in a unidirectional and/or bidirectional way, including a system for modulating the variation or the change of the volumetric spatial disposition of the structural flow regulator barrier, from an initial state to a second state, wherein the initial state blocks the passing channel and the second state allows the passing through the channel in a unidirectional and/or a bidirectional way.

2. The plug of claim 1, wherein the structural flow regulator barrier permanently blocks the channel unless the access is unlocked by the application of a perpendicular force over the gate surface exerted by a solid body, which causes a variation of spatial arrangement over the gate itself, allowing the mentioned solid body to pass through the passing channel.

3. The plug of claim 1, wherein the plug comprises a system to reset the initial volumetric spatial disposition of the gate position when the perpendicular force exerted by a solid body over the regulator barrier is no longer exerted.

4. The plug of claim 1, wherein the access is activated by the application of a force without breaking or causing any structural damage to the plug, so can be reused in a specific, variable or unlimited amount of times, and wherein the plug can be operated with the interaction of a range of solid objects.

5. The plug of claim 4, wherein the range of solid objects for interaction with the plug comprises: rounded, sharp, conical, flat and beveled objects, and any combination of them.

6. The plug of claim 1, wherein the plug is made of an elastomer material, wherein the elastomer material can be selected from at least one of the followings materials: is chosen from styrenics, olefinic, vulcanized thermoplastics, thermoplastic polyurethane, copolyesters, and copolyamides materials.

7. A method for manufacturing the plug of claim 1, wherein the method comprises at least one of the following stages:
a. pre-analysis, and
b. materialization,
wherein, the stage of pre-analysis comprises:
a1. observation for detection of possibility of intervention,
a2. problematization,
a3. solution strategy, and
a4. design proposals;
and wherein the stage of materialization comprises:
b1. mock-up,
b2. modeling for the physical and actual representation of the plug,
b3. digital prototype and template,
b4. manufacture of template and prototype,
b5. performance evaluation,
b6. testing prototype in real conditions, use and circumstances, and
b7. scaled production

8. The method of claim 7, wherein the step of manufacturing the template and prototype comprises at least one of the following steps: 1) casting in combination with a rapid prototyping tool manufacturing process to obtain the positive (mold); 2) 30 printing; 3) machining by roughing, for instance by a manual, computerized or mixed process; and 4) conforming by deposition of material.

9. The method of claim 7, wherein the step of manufacturing of template and prototype comprises a conformation molding process, including the elaboration of a mold for conforming at least one unit of a single-piece plug.

10. The method of claim 9, wherein the mold for conforming the plug comprises elaboration of multiple units of a single-piece plug, simultaneously or successively.

11. The method of claim 7, wherein the scaled production includes at least one of the following steps: 1) casting, 2) injection molding, and 3) extrusion molding.

12. The method of claim 7, wherein the materialization stage comprises any format of computer-readable information directly, intentional or derived from digital prototyping or a manufacturing process involving the use of an automated machine, preferably at any time of the manufacture process.

13. The method of claim 12, wherein the computer-readable information comprises at least one of the following: numerical control programming language, parametric design approach, mesh design approach, and any combination of them.

14. A plug for a flask or container, preferably made of one piece, produced by the method according to claim 7.

15. A plug/container assembly, comprising (1) a flask or a container and (2) a plug according to claim 1, the plug being attached or connected to the flask or container.

16. The Plug/container assembly according to claim 15, wherein the container or flask comprises a sample.

17. Use of the plug of claim 1, wherein include the plug in a sample analysis pipeline improves the time of processing set of samples, by reducing time of at least 5%, preferably 10%, preferably 20%, preferably 30%, preferably 40%, preferably 50% preferably 60% of the total time for sample processing.

18. The use of the plug of claim 17, wherein improving the time of processing set of samples in a sample analysis pipeline, includes an optimization resource in the processing of samples from productive contexts, since it allows to reduce and optimize the use of resources, wherein resources can include at least one of the followings: physical resources, human resources, material resources, economical resources, and any combination of them.
